(19) United States
(12) Patent Application Publication
(10) Pub. No.: US 2006/0218751 A1
(43) Pub. Date: Oct. 5, 2006

(54) Hinge

(76) Inventors: Tae Hoon Kim, Gyeonggi-do (KR); Tae Eun Kim, Bucheon-si (KR)

Correspondence Address: LADAS & PARRY LLP, 224 SOUTH MICHIGAN AVENUE, SUITE 1600, CHICAGO, IL, 60604, US

(21) Appl. No.: 11/391,997

(22) Filed: Mar. 29, 2006

(30) Foreign Application Priority Data
Apr. 1, 2005 (KR) KR20-2005-0008944

(51) Int. Cl. E05D 5/02

(52) U.S. Cl. 16/387

(57) ABSTRACT

Provided is a hinge. The hinge includes: a rotating plate which includes a plurality of pin fixing holes and at predetermined portions of both the ends of which a respective fixing groove is correspondingly formed; a fixing plate which includes an opening through which the rotating plate is fitted and at predetermined portions of the inner side of which a respective fixing groove is correspondingly formed and a plurality of pin fixing holes are perforated; and a hinge combiner unit which connects and disconnects the rotating plate with and from the fixing plate. Accordingly, since the fixing plate and the rotating plate are connected with or disconnected from the hinge combiner unit, the different materials can be applied to the fixing plate, the rotating plate, and the hinge combiner unit, to thus save the production cost.

### CROSS-REFERENCE TO RELATED PATENT APPLICATION

This application claims the benefit of Korean Utility Model Registration Application No. 20-2005-0008944, filed on Apr. 1, 2005, in the Korean Intellectual Property Office, the disclosure of which is incorporated herein in its entirety by reference.

### BACKGROUND OF THE INVENTION

1. Field of the Invention

The present invention relates to a hinge, and more particularly, to a hinge installed at all kinds of hinged doors.

2. Description of the Related Art

In general, a hinge connects a door frame with a hinged door, and performs a function of rotatably opening and closing the hinged door. So far, a variety of structured hinges have been proposed. FIG. 1A is a perspective view showing a representative example of a conventional hinge.

Referring to the FIG. 1A, a conventional hinge 1 has a structure that a fixing plate 2 and a rotating plate 3 whose sizes and shapes are identical rotate freely around a hinge shaft 6. A respective hinge combiner pieces 4 which is inserted into a hinge shaft 6 is extended in a mutually correspondingly zigzag form on the fixing plate 2 and the rotating plate 3, respectively. According to this kind of the configuration, the conventional hinge 1 fixes the fixing plate 2 on the door frame and combines the rotating plate 3 with a hinged door. The hinge combiner pieces 4 respectively formed on the fixing plate 2 and the rotating plate 3 are fitted with each other, and then combined with the hinge shaft 6, to finally complete the assembly of the hinge and the hinged door.

However, in the case of the conventional hinge 1, the fixing plate 2 and the rotating plate 3 each which has a predetermined thickness overlap each other when the hinged door is opened or closed. Accordingly, there is a problem that a wide gap between the door frame and the hinged door interval is formed. To solve this kind of a problem, grooves should be formed at positions where the hinge is assembled in the case that the door frame and the hinged door are made of timber. Further, in the case that the door frame and the hinged door are made of metal, there is a disadvantage that it is much difficult to process the door frame and the hinged door, to avoid a wide gap between the door frame and the hinged door when the hinged door is opened or closed.

Moreover, in the case of the conventional hinge 1 the hinge 1 as described above, the hinge shaft 6 should be installed at the state where the fixing plate 2 and the rotating plate 3 have been fixed to the door frame and the hinged door. As a result, the assembly work is troublesome. That is, in order to accurately open and close the hinged door, the fixing plate 2 and the rotating plate 3 should be fixed on the exact locations. Since the hinge shaft 6 should be fixed in this state, two or more workers are needed to assemble the hinged door with the door frame.

In the meantime, an improvement of the above-described conventional hinge is provided in Japanese Utility Model Laid-Open Publication No. Sho-59-102774. FIG. 1B is a perspective view illustrating a hinge proposed in the Japanese Utility Model Laid-Open Publication No. Sho-59-102774.

Referring to FIG. 1B, in the case of the hinge 10 disclosed in the Japanese Utility Model Laid-Open Publication No. Sho-59-102774, the fixing plate 11 and the rotating plate 12 constituting the hinge are formed using a sheet of a steel plate. That is, a sheet of the steel plate is pressed in the form of a “C” shape, and thus a “C”-shaped steel plate which is formed by cutting the inner portion of the whole steel plate is used as the fixing plate 11, and a “ ”-shaped steel plate which is formed by cutting the inner portion of the whole steel plate is used as the rotating plate 12. Accordingly, the fixing plate 11 and the rotating plate 12 are assembled on a coplanar. As a result, there are advantages that a gap between a door frame and a hinged door can be minimized and the fixing plate 11 and the rotating plate 12 can be installed in the hinged door at the state where the fixing plate 11 and the rotating plate 12 have been assembled with each other.

However, in the case of the hinge 10 disclosed in the Japanese Utility Model Laid-Open Publication No. Sho-59-102774, the hinge combiner pieces 14 should be bent and formed in one end of each of the fixing plate 11 and the rotating plate 12, in the form of a hollow cylindrical tube, in order to combine the fixing plate 11 and the rotating plate 12 with the hinge shaft 16. As a result, it is difficult to manufacture the hinge. Also, the production cost rises up in the case that non-ferrous metal is applied as a material of the fixing plate 11 and the rotating plate 12.

Further, the above-described hinge combiner pieces 14 are bent and formed only in the form of a hollow cylindrical tube so that a rod-shaped hinge shaft 16 can be installed. As a result, it is difficult to change the shape of the hinge. Since washers interposed between the hinge combiner pieces 14 are exposed outwards, the outer appearance is not beautiful. Thus, the incompatibility of the hinged door and the hinge can be brought up, which may cause a factor which hinders the esthetic sense. Also, various tastes of consumers cannot be satisfied to thereby cause a quality of products to be lowered.

### SUMMARY OF THE INVENTION

To solve the above problems of the conventional art, it is an object of the present invention to provide a hinge which can improve an assembly performance since a fixing plate and a rotating plate are connected with or disconnected from a hinge combiner unit which can be fabricated in various forms.

It is another object of the present invention to provide a hinge in which respectively different materials can be applied to a fixing plate, a rotating plate, and a hinge combiner portion, to thus save the production cost, since the fixing plate and the rotating plate are connected with or disconnected from the hinge combiner portion which can be fabricated in various forms, and which can be realized in various forms to thereby enhance performance and features of products and thus satisfy the tastes of consumers.

To accomplish the above object of the present invention, there is provided a hinge comprising: a rotating plate which includes a plurality of pin fixing holes; a fixing plate which includes an opening through which the rotating plate is fitted and a plurality of pin fixing holes are perforated; and a hinge combiner unit which connects with and disconnects from the rotating plate and the fixing plate.

Preferably, the hinge combiner unit comprises:

a pair of fixing plate coupling members which are fixed to either side of the fixing plate by means of pins and provided with a first tapered accommodation groove on one end of a respective throughhole formed in the fixing plate coupling members;

a rotating plate coupling member which is fixed to one side of the rotating plate by means of pins, and provided with a second tapered accommodation groove on one end of a respective throughhole formed in the rotating plate coupling member;

a hinge shaft which is installed in order to pass through the inside of the rotating plate coupling member;

a pair of second hinge shaft installation members which are inserted into and installed in both ends of the rotating plate coupling member, and provided with a respective throughhole through which the hinge shaft passes, in which a respective accommodation protrusion is provided in one end of the second hinge shaft installation members so as to be accommodated in the second accommodation groove;

a pair of first hinge shaft installation members which are installed in contact with the second hinge shaft installation members, at the state where the first hinge shaft installation members have been fixed to the fixed plate coupling members, respectively, and provided with a respective installation groove supporting and fixing both ends of the hinge shaft and a respective accommodation protrusion accommodated in the first accommodation groove, in one end of the first hinge shaft installation members, respectively, and a respective fitting protrusion protrudingly formed in the other end thereof; and

a closing member which is inserted into and fixed to the fitting protrusion of the first hinge shaft installation members, respectively, so as to be fixed to the other end of the fixing plate coupling members, respectively.

Preferably, a respective first fixing groove is correspondingly formed at predetermined portions of both the ends of the rotating plate, and a respective second fixing groove is correspondingly formed and a plurality of pin fixing holes are perforated at predetermined portions of the inner side of the fixing plate.

### BRIEF DESCRIPTION OF THE DRAWINGS

The above and other objects and advantages of the present invention will become more apparent by describing the preferred embodiment thereof in more detail with reference to the accompanying drawings in which:

FIG. 1A is a perspective view showing a representative example of a conventional hinge;

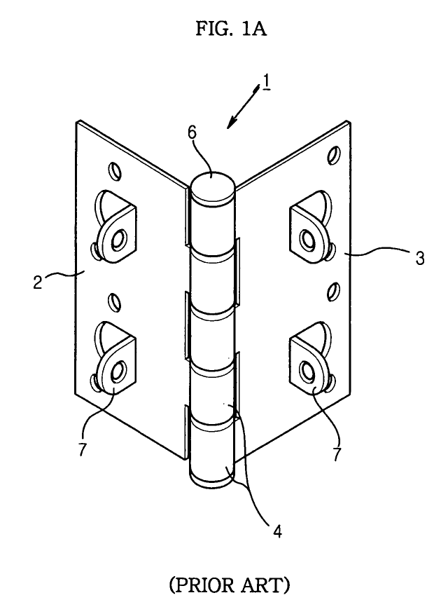

FIG. 1B is a perspective view for illustrating a hinge proposed in the Japanese Utility Model Laid-open Publication No. Sho-59-102774;

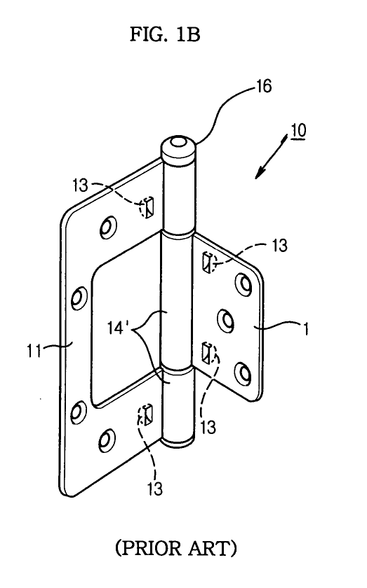

FIG. 2 is an exploded perspective view of a hinge according to the present invention;

FIG. 3 is a combined perspective view of the hinge according to the present invention;

FIG. 4 is a cross-sectional view of the hinge according to the present invention; and

FIG. 5 is a configurational view showing the state where the hinge according to the present invention is combined with a door frame and a hinged door.

### DETAILED DESCRIPTION OF THE INVENTION

A hinge according to a preferred embodiment of the present invention will be described with reference to the accompanying drawings. The similar elements are assigned with the similar or same reference numbers of characters.

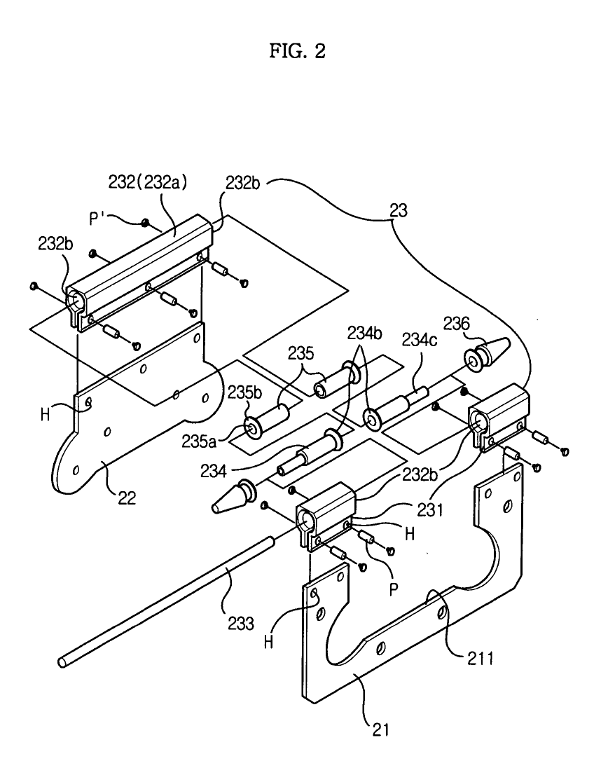

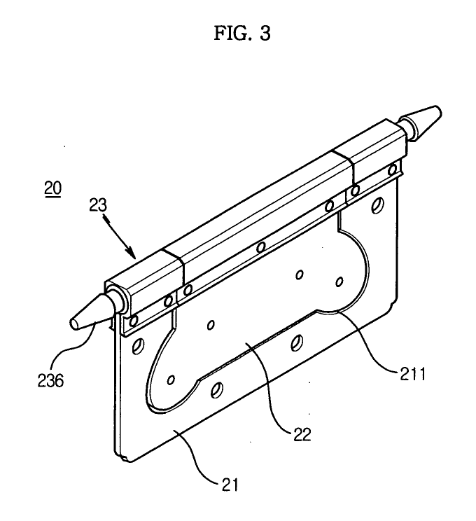

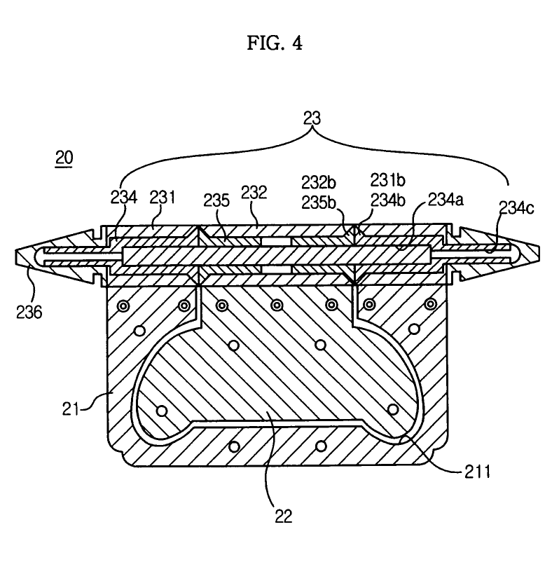

FIG. 2 is an exploded perspective view of a hinge according to the present invention. FIG. 3 is a combined perspective view of the hinge according to the present invention. FIG. 4 is a cross-sectional view of the hinge according to the present invention.

Referring to FIGS. 2 and 4, a hinge 20 according to the present invention is provided with a fixing plate 21 including an opening 211 and a rotating plate 22 which can be assembled with the fixing plate 21 on a co-plane. Also, a hinge combiner unit 23 which enables the rotating plate 22 to rotated around the fixing plate 21 can be connected with or disconnected from the fixing plate 21 and the rotating plate 22.

The fixing plate 21 is formed of a rectangular plate shape. The fixing plate 21 is provided with the opening 211 through which the rotating plate 22 is fitted. A number of pin fixing holes H which are fixed to a pair of fixing plate coupling members 231 and a number of screw holes H which are fixed to a door frame are perforated in the fixing plate 21.

The rotating plate 22 is formed of a plate-shaped member of the same shape as that of the opening 221. A number of pin fixing holes H which are fixed to a rotating plate coupling member 232 and a number of screw holes H which are fixed to a hinged door are perforated in the rotating plate 22.

Here, a general steel plate or a non-ferrous metal plate is used for the fixing plate 21 and the rotating plate 22. The general steel plate is preferably used for reducing a production cost.

The hinge combiner unit 23 is provided with a pair of fixing plate coupling members 231, a rotating plate coupling member 232, a hinge shaft 233, first and the second hinge shaft installation members 234 and 235, and closing members 236.

The pair of fixing plate coupling members 231 are fixed to either side of the fixing plate 21 by means of pins and provided with a first tapered accommodation groove 231b on one end of a respective throughhole 231a formed in the fixing plate coupling members 231. The rotating plate coupling member 232 is fixed to one side of the rotating plate 22 by means of pins, and provided with a second tapered accommodation groove 232b on one end of a respective throughhole 232a formed in the rotating plate coupling member 232. The fixing plate coupling members 231 and the rotating plate coupling member 232 can be formed by a molding or extruding method, to thereby reduce a manufacturing cost. It is preferable that a non-ferrous metal material is used for the fixing plate coupling members 231 and the rotating plate coupling member 232 in order to heighten quality of the product. Moreover, it is preferable that a pin decoration member P’ of a diamond shape is installed on the head of the pin P which couples the coupling members 231 and 232 with the fixing plate 21 and the rotating plate 22, respectively.

The hinge shaft which is formed of a hollow cylindrical shape is installed in order to pass through the inside of the rotating plate coupling member 232.

The pair of second hinge shaft installation members 235 are inserted into and installed in both ends of the rotating plate coupling member 232, and provided with a respective throughhole 235a through which the hinge shaft 23 passes, in which a respective accommodation protrusion 235b is provided in one end of the second hinge shaft installation members so as to be accommodated in the second accommodation groove 232b. The pair of first hinge shaft installation members 234 are installed in contact with the second hinge shaft installation members 235, at the state where the first hinge shaft installation members 234 have been fixed to the fixed plate coupling members 231, respectively, and provided with a respective installation groove 234a supporting and fixing both ends of the hinge shaft 233 and a respective accommodation protrusion 234b accommodated in the first accommodation groove 231b, in one end of the first hinge shaft installation members 234, respectively, and a respective fitting protrusion 234c protrudingly formed in the other end thereof 234. It is preferable that the first and second hinge shaft installation members 234 and 235 are formed of a synthetic materials so as to suppress noise generated during rotation of the rotating plate 22 and make the rotating plate 22 smoothly rotate.

Finally the closing member 236 is inserted into and fixed to the fitting protrusion 234c of the first hinge shaft installation members 234, respectively, so as to be fixed to the other end of the fixing plate coupling members 231, respectively.

Hereinafter, an installation process of the hinge constructed above will be described.

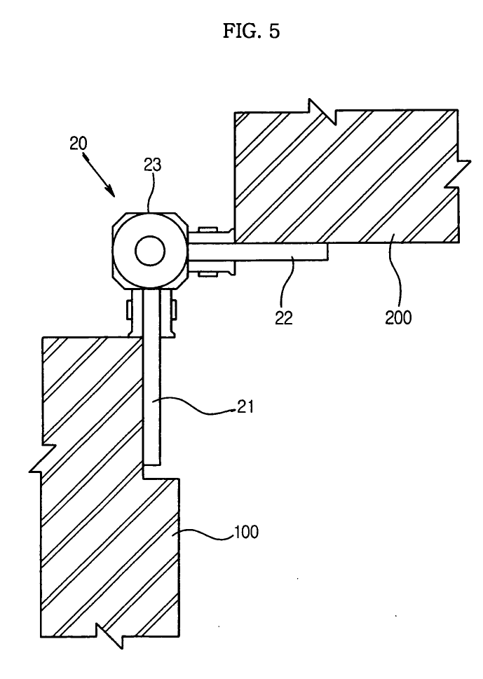

FIG. 5 is a configurational view showing the state where the hinge according to the present invention is combined with a door frame and a hinged door.

Referring to FIG. 5, in the hinge 20 of the present invention, the fixing plate 21 is combined with a door frame 100, and the rotating plate 22 is combined with a hinged door 200. Accordingly, the hinge 20 operates so that the hinged door 200 freely opens through the rotating operation of the rotating plate 22 by the hinge combiner unit 23.

Here, the first and the second hinge shaft installation members 234 and 235 performing functions of washers are accommodated in the fixing plate coupling members 231 and the rotating plate coupling member 232. The first and second hinge shaft installation members 234 and 235 are not advantageously exposed externally. As a result, the hinge according to the present invention has several merits of obtaining an aesthetic sense, in which the hinge naturally matches the door frame 100 and the hinged door 200, to thereby satisfy a variety of the tastes of users. Further, a general steel plate is used for the rotating plate 22 and the fixing plate 21 and a non-ferrous metal material is used for the fixing plate coupling members 231 and the rotating plate coupling member 232 of the hinge combiner unit 23, the quality of the product can be improved and the manufacturing cost is cut down.

As described above, the hinge combiner unit can be connected with and disconnected from the fixing plate and the rotating plate is respectively, in the hinge according to the present invention. A general steel plate is used for the rotating plate 22 and the fixing plate 21 and a non-ferrous metal material is used for the fixing plate coupling members 231 and the rotating plate coupling member 232 of the hinge combiner unit 23. Accordingly, the quality of the product can be improved and the manufacturing cost is cut down since the different materials are used for the fixing plate, the rotating plate, the fixing plate coupling members, and the rotating plate coupling member. Further, the separably coupled hinge combiner unit enables the hinge to be fabricated in various forms, to thereby enhance performance and features of products and thus satisfy the tastes of consumers. In particular, since the first and second hinge shaft installation members are accommodated in the fixing plate coupling members and the rotating plate coupling member, respectively, the esthetic sense can be doubled.

As described above, the present invention has been described with respect to a particularly preferred embodiments. However, the present invention is not limited to the above embodiments, and it is possible for one who has an ordinary skill in the art to make various modifications and variations, without departing off the spirit of the present invention.

1. A hinge comprising:
a rotating plate which includes a plurality of pin fixing holes;
a fixing plate which includes an opening through which the rotating plate is fitted and a plurality of pin fixing holes are perforated; and
a hinge combiner unit which connects with and disconnects from the rotating plate and the fixing plate.

2. The hinge according to claim 1, wherein said hinge combiner unit comprises:
a pair of fixing plate coupling members which are fixed to either side of the fixing plate by means of pins and provided with a first tapered accommodation groove on one end of a respective throughhole formed in the fixing plate coupling members;
a rotating plate coupling member which is fixed to one side of the rotating plate by means of pins, and provided with a second tapered accommodation groove on one end of a respective throughhole formed in the rotating plate coupling member;
a hinge shaft which is installed in order to pass through the inside of the rotating plate coupling member;
a pair of second hinge shaft installation members which are inserted into and installed in both ends of the rotating plate coupling member, and provided with a respective throughhole through which the hinge shaft passes, in which a respective accommodation protrusion is provided in one end of the second hinge shaft installation members so as to be accommodated in the second accommodation groove;
a pair of first hinge shaft installation members which are installed in contact with the second hinge shaft installation members, at the state where the first hinge shaft installation members have been fixed to the fixed plate coupling members, respectively, and provided with a respective installation groove supporting and fixing both ends of the hinge shaft and a respective accommodation protrusion accommodated in the first accommodation groove, in one end of the first hinge shaft installation members, respectively, and a respective fitting protrusion protrudingly formed in the other end thereof; and
a closing member which is inserted into and fixed to the fitting protrusion of the first hinge shaft installation members, respectively, so as to be fixed to the other end of the fixing plate coupling members, respectively.

3. The hinge according to claim 2, wherein a respective first fixing groove is correspondingly formed at predetermined portions of both the ends of the rotating plate, and a respective second fixing groove is correspondingly formed and a plurality of pin fixing holes are perforated at predetermined portions of the inner side of the fixing plate.
